(19) United States
(12) Patent Application Publication
(10) Pub. No.: US 2007/0268145 A1
(43) Pub. Date: Nov. 22, 2007

(54) Automated tailgating detection via fusion of video and access control

(76) Inventors: Michael E. Bazakos, Bloomington, MN (US); Yunqian Ma, Roseville, MN (US); Kwong Wing Au, Bloomington, MN (US)

Correspondence Address: Kris T. Fredrick, Esq.;Patent Services, Honeywell International Inc., 101 Columbia Road, Morristown, NJ, 07962, US

(21) Appl. No.: 11/437,461

(22) Filed: May 19, 2006

(51) Int. Cl. G08B 23/00; G08B 21/00; H04N 7/18; G08B 19/00

(52) U.S. Cl. 340/573.1; 340/540; 348/143; 340/521

(57) ABSTRACT

An automated tailgating detection system for an entry through a door or other entry port, including an entry authorization sensor detecting valid entry credentials and transmitting the number of valid entry credentials detected. An automated video surveillance system detects, counts and tracks the persons who enter through the door. A tailgate detection processor receives the number of valid entry credentials detected and the number of people detected and sounds an alarm when the credentials number is less than the number of persons. A door contact sensor determines the state of the door, and sends a signal when the door is opened and closed.

### FIELD OF THE INVENTION

The present invention relates to access control systems (ACS). More particularly, the invention relates to an access control system that detects a tailgate event which is the act of one or more persons getting through an ACS restricted entrance without presenting proper authorization, by getting in behind (or in front or along side) of a person who opened the restricted entrance with proper authorization before the door closes and locks.

### BACKGROUND OF THE INVENTION

Typical Access Control Systems (ACS) allow access to more than one person through a secure door or gate once the credentials of one authorized person have been validated. Typically the traditional ACS requires that an individual type in a PIN on a pad, or use a badge, proximity card, swipe a card or one fingerprint on a reader, and the like. The problem with such systems is that they are “dumb” or, stated another way, are not intelligent and thus cannot recognize the existence of other persons in the vicinity. One can picture the authorized person holding the door open for escorted visitors. What is not wanted and what becomes a serious security breech and a major concern for Security Management is when someone enters by following closely on the heels of an authorized person, whether or not known to that authorized person, and enters without presenting valid credentials. This is known as “tailgating’ and is an increasingly serious problem in this less than secure world.

Tailgating can happen either intentionally or by clever concealment by one who is seeking unauthorized access, such as by standing near a door, pretending to be talking to a colleague, waiting for an authorized access by a person, and preventing the door from closing or latching to require access. One example of present day tailgate detection systems is currently manufactured and sold by Kouba Systems, in which a basic tailgate detection system using Model LDA-TG has a local door alarm and doorway mounted sensors to determine an annunciate unauthorized passage through the door. A card is used to open the door from the outside secure area side of the door. Exit from the secure area does not require identification or permission. A more advanced system sold by Kouba Systems using Model TG-OS is installed in doorways that are wide enough for two persons to pass through at the same time, such as double doors. A card or other identification device is required for each side of the double doors. Both systems employ sensors such as optical beam sensors that is triggered when a person walks through the doorway in the entry direction without presenting a valid card, but since the beam is off, there is no way to detect the presence of a second person entering within the window that the beam is off or not set to sound an alarm.

There is no provision monitoring or prohibiting more than one person from entering once an authorized card has been presented to the card reader. The devices claim to function as tailgating detection systems but actually functions as an entry and exit system in which authorized entry is permitted and forced entry or unauthorized entry is detected and announced via an alarm.

One portal intrusion detection apparatus and method is described in U.S. Patent Application Publication No. US 2002/0067259, published Jun. 6, 2002, in which a camera and other sensors are combined to monitor the area proximate a portal. The camera is described in paragraph 0051 as being activated by an alarm signal to record the events occurring in the area of the security door. Otherwise the camera is like those that are monitored by security guards.

Another tailgating and reverse entry detection system is disclosed in PTC Application No. WO 03/088157 A1, published Oct. 23, 2003

It would be of advantage in the art if a true tailgate detection system could be provided that would actually monitor the traffic at a secure location entry and/or exit location. This system uses a stereo camera to count people by a machine vision method having a three-dimensional surface analysis of objects in the image. Merely counting people within the field of view may cause a false alarm when additional people are already inside the field of view. A third camera is employed to film and display activity in an area near a secure door or the like, in which security personnel use the images to investigate a situation that another source of alarm has noted.

Yet another advantage would be if the true tailgate detection system could be provided so that it automatically identifies each and every person attempting to enter or exit, to distinguish between those with authorization and those without authorization.

Other advantages will appear hereinafter.

### SUMMARY OF THE INVENTION

It has now been discovered that the above and other advantages of the present invention may be obtained in the following manner. Specifically, the present invention provides a system for automatically detecting tailgating entry to secure areas by a combination of access control and personnel count during each interval between recognitions of credentialed access signals using an automated video surveillance system. The system of this invention counts the number of valid credentials presented over the same time interval and counts the number of people passing through the door. Only when the number of valid credentials is less than the number of people passing through the door does the system determine that there has been a tailgating violation.

The system includes an entry authorization sensor, which may be a key pad for entry of a PIN, a card that is swiped, a badge that can be sensed by the authorization sensor, a fingerprint or iris reader or other devices that authenticate the credentials of one seeking entry to a secured area. Data from the entry authorization sensor is sent to a tailgate detection processor, which may be a stand-alone CPU or may be operably connected to a larger system, perhaps including the entire facility.

Also included is a door contact sensor that determines if the door is open or shut. Data from the door contact sensor also is transmitted to the tailgate detection processor.

The system of this invention also includes an automated video surveillance system that employs a camera or cameras to view the area proximate to the entry door of interest and compares (via image processing algorithms running on a computer) images taken by the camera with predetermined data, such as silhouettes or models of persons and other shapes that appear when someone or some thing approaches the door of interest. Images from the camera are transmitted to the tailgate detection processor directly for comparison with said predetermined data, or the images may be compared in a separate device that then transmits its data to the tailgate detection processor. One or more cameras may be employed, inside and/or outside the secure area, and different elevations and angles with respect to the area proximate the door, it being preferred that the placement of a camera or cameras optimize the view of the area of interest. When more that one camera is used, a fusion method is employed to combine the image processing algorithm results from each camera or even combine the raw video data first and then process with the algorithms, so that more robust people detection and counting can be accomplished.

When the number of person entries in a “tailgate detection cycle,” which is the time interval from a valid credential entry to door closed, is more than the number of valid credential entries, such as if two persons enter through the door when only one valid credential entry has been entered, a tailgate detection signal is sent to the ACS, where appropriate actions are invoked. For example, an alarm is sounded. The alarm may be audible, thus alerting security officials stationed nearby, or it may be a silent alarm. Another action may be also to shut and lock the door of interest, or may lock down the entire facility.

In a preferred embodiment of the present invention, auxiliary sensors such as motion sensors, acoustic sensors, seismic sensors, pressure sensors in the pathway and the like may be included in the system to provide additional motion information to the tailgate detection processor. These auxiliary sensors serve to enhance the confidence of tailgate detection, to reduce false alarms, and to insure that two or more persons acting in concert do not confuse the video surveillance data being taken.

Once the proper number of valid credentialed entry signals and the number of person entries detected by the video surveillance system are determined to be less than or equal and the door is locked again, the system resets itself, waiting for the next valid credentialed entry signal.

### BRIEF DESCRIPTION OF THE DRAWINGS

For a more complete understanding of the invention, reference is hereby made to the drawings, in which:

FIG. 1 is a schematic illustration of the basic components of the system of the present invention;

FIG. 2 is a schematic illustration of one embodiment of a camera configuration used in the system of the present invention; and

FIG. 3 is a schematic flow diagram illustrating the operation of the tailgate detection system used in the present invention.

### DETAILED DESCRIPTION OF THE PREFERRED EMBODIMENT

The present invention provides for substantial improvements in automated tailgate detection systems that determine when more than the authorized number of persons pass through a secured door. By the term “secured door” is meant any means for entry from one unsecure area to a secured area, including but not limited to doors, turnstiles, open portals, metal detectors, hallways, ramps and revolving doors. The system of this invention may include larger doors, double doors, overhead sliding doors and the like. The system will be understood to include as many components as are needed to fully function as described below, regardless of the nature of the door of interest.

The tailgating detection system of the present invention includes a plurality of components to determine the number of persons entering through a door or other entry port into an area of interest such as from an unsecure area to a secured area.

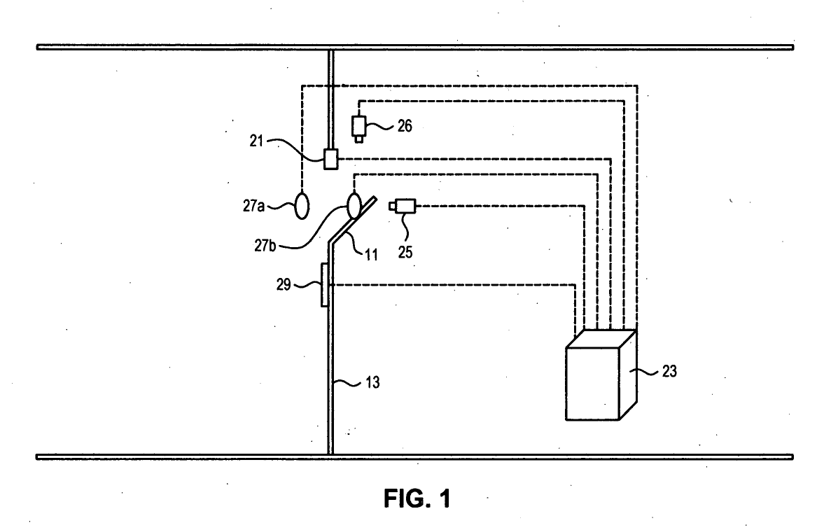

As seen in FIG. 1, a door 11 on wall 13 separates the common area 15 from secure area 17. On wall 13, the system includes an entry authorization sensor 21 operable to detect a valid entry credential presented at door 11, and transmit a signal indicative of the number of valid entry credentials detected. Typically sensor 21 will sense one signal as a person approaches door 11 and presents his or her credentials. The credential may be presented by entry of a PIN on a key pad, or by swiping a card through a slot, or by sensor 21 reading a badge worn by the person, or by fingerprint or iris identification or other means for determining the identity of the person seeking entrance through door 11.

The sensor 21 sends a signal to a tailgate detection processor 23 that processes the signal and determines the number of valid entry credentials presented. Typically this number is just one, but the system will accommodate presentations of multiple valid credentials.

An automated video surveillance system, which consists of the camera suite and tailgate detection processor 23 is used to capture and transmit images of persons proximate said door and to determine the number of persons entering through said door. Cameras 25 in FIG. 1 illustrates the simplest form of the camera suite in the automated surveillance system, and sends images of persons, or other objects, that present themselves at the door area surveyed by the cameral 25. Camera 25 may be any camera that produces images that may be compared to images by tailgate detection processor 23 to identify people in images. A preferred embodiment has two cameras 25 and 26 capturing images at two perspectives. The two cameras are arranged at an angle, e.g., 90°, with respect to the door, such that one will capture the top view and the other will capture a side view. Such arrangement will prevent shading of a person by another in both cameras. The type of cameras 25 and 26 may be of different spectral bands, e.g., visible or infra-red cameras.

The tailgate detection processor 23 automatically computes (via computer vision algorithms, i.e., image processing algorithms running on a computer) the number of people who entered through the door in the images from the camera suite. Advanced image processing algorithms are applied to each image stream from each camera 25, 26. As an example, inputs into the algorithms are the original images from the cameras. The algorithms then estimate a reference image background. Background subtraction process removes the static background from the input images and then a template-based people recognition algorithm detects the presence of a person or persons. Subsequently, the results from the camera suite are combined. Any conflicts among the images and results from the different cameras are resolved to yield consistent, unambiguous people segments and counts as follows: When more than one camera is used, a fusion method is employed to combine the image processing algorithm results from each camera or even combine the raw video data first and then process with the algorithms, so that more robust people detection and counting is accomplished.

The movements of the people are tracked in a “tailgate detection cycle” and those who pass through the door from the unsecure area to the secured area are counted. Another embodiment first applies homography to combine the images from the camera suite using the known geometric camera configuration. This process can be augmented with a site model of the physical area which is viewed (imaged) by the camera or cameras. Then a three dimensional model-based people recognition technique can be applied to extract, track and count the people movement through the door. The tailgate detection processor 23 compares the credential number of valid entry credentials with the number of people detected entering. Inside the tailgate detection processor 23 is a signal generator for sending an alarm when said credential number is less than people number. The tailgate detection processor 23 is also responsible for the sequencing of, and performing the functions in, the tailgate detection cycle as discussed later.

Also shown in FIG. 1 are auxiliary sensors 27a and 27b, which are sensors that detect motion, sounds such as footsteps, pressure on the pathway and the like. These sensors also communicate with the tailgate detection processor 23 to assist in image recognition and defeat any attempt to avoid detection by two or more persons acting in concert. The tailgate detection processor 23 also is connected to a door contact sensor 29, which determines the state of door 11, whether open or closed, and, further determines if an effort is being made to force open door 11 with no valid credential. Preferably the door sensor 29 will send a signal when door 11 closes, and that signal may be used to reset the tailgate detection cycle in the tailgate detection processor 23 after a valid entry has been allowed.

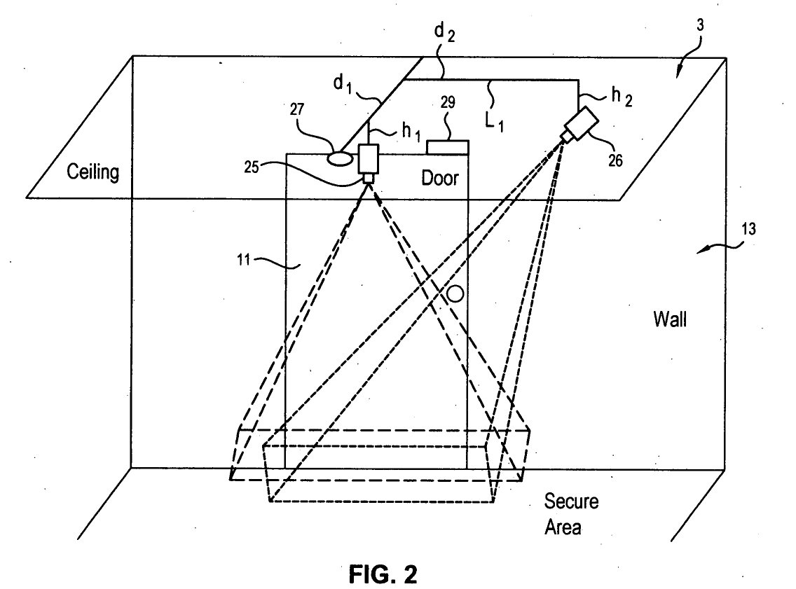

The automated video surveillance system (image processing algorithm based) of this invention is an important component of the invention and may include a plurality of cameras as shown in FIG. 2. The cameras may have a variety of lenses, such as wide angle, telephoto, and the like. Cameras 25 and 26 are positioned based on the geometric constraints determined by the ceiling 35, walls 13 and size of the door 11. Camera 25 has height h₁ from ceiling 35 and is spaced from wall 13 by d₁. Camera 26 has height h₂ from ceiling 35 and is spaced from wall 13 by d₂, and cameras 25 and 26 are spaced from each other by length L₁. It is critical that the camera's field of view covers the area on both the secure and unsecure sides which the door separates. In other words, the FOV of the camera should enable the detection of people entry through the door. This is one example of the use of multiple camera deployments in order to optimize the camera configuration based on the environment where the system is to be used.

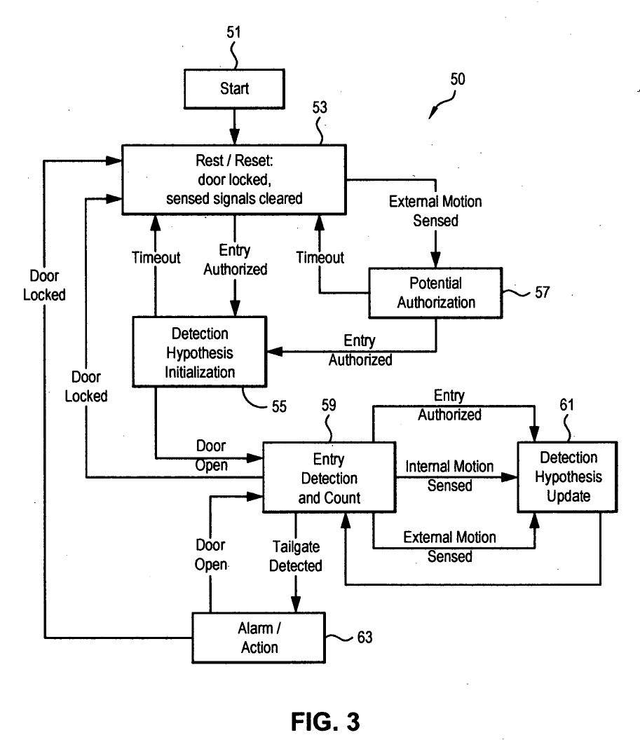

The tailgate detection processor 23 conducts the tailgate detection in a cycle from an authorized entry presentation and door open until the door closes. In FIG. 3, the tailgate detection process, 50 generally, of the present invention is seen in finite state machine, where the Start state 51 sends a command to Reset state 53, in which the system logic is initialized and/or reset, the door is locked, and all sensed signals are reset to their initial states. Upon use of a valid credential, entry is authorized and the state 53 switches to the tailgate Detection Hypothesis Initialization state 55, which sets up hypotheses and conditions to detect a potential tailgate event. Having completed its functions, state 55 waits for the door open signal before transitioning to the Entry Detection and Count state 59. If no door open signal is received after a set time, the door is locked and the state 55 returns to state 53. In the event that the system includes additional sensors, motion detection from those sensors will cause a transition from state 53 to the Potential Authorization state 57. Once authorized entry is received, state 57 switches to state 55. Otherwise, after a set time has elapsed, state 57 times out, clears its prior probability and returns to state 53. With both a valid credential and available appropriate auxiliary sensor reports, the Entry Detection and Count state 59 receives and processes images from the camera suite. That is, state 59 computes the number of people who entered through the door in the images from the camera suite as described above. During the processing at state 59, the tailgate detection processor 23 may receive additional entry authorization and auxiliary sensor reports. In such case, state 59 switches to the Detection Hypothesis Update state 61, which revises the detection hypotheses, prior probabilities and immediately returns to state 59. State 59 terminates and transitions back to state 53 when the door locked signal is received and no tailgate is detected. When state 59 detects tailgate, it immediately switches to the Alarm/Action state 63, which sends out tailgate detected signals to the ACS and invokes actions that the user has assigned. State 63 then returns to state 59 if the door is still open. Or else, state 63 returns to state 53 if the door is locked. Additional functions within each state can be added to enhance the tailgate detection and reduce false alarms. For example, state 63 may transmit the image sequences of the tailgate event to the ACS. Likewise, additional states can be added to refine the tailgate detection process.

While particular embodiments of the present invention have been illustrated and described, it is not intended to limit the invention, except as defined by the following claims.

1. An automated tailgating detection system for an entry through a door or other entry port into an area of interest, comprising:
an entry authorization sensor operable to detect a valid entry credential presented at said door, and transmit a signal indicative of the number of valid entry credentials detected;
a tailgate detection processor for receiving said signal indicative of the number of valid entry credentials detected;
a door contact sensor for determining the state of said door, and adapted to send a signal to said tailgate detection processor when said door is opened and/or closed.
an automated video surveillance system, which captures images and includes image processing algorithms and perhaps fusion algorithms, for detecting persons proximate passing through said door and transmitting said images to said tailgate detection processor for determination of the number of persons entering through said door;
said tailgate detection processor being adapted to compare the credential number of valid entry credentials detected with the number of persons detected entering; and
an alarm mechanism for triggering an alarm when said credential number is less than said image number.

2. The system of claim 1, which further includes a motion sensor for detecting motion in the area proximate said door and transmitting a signal indicative of the presence of movement in said area to said tailgate detection processor, said tailgate detection processor being adapted to compare the credential number of valid entry credentials detected with the number of persons detected entering upon receipt of said motion sensor signal.

3. The system of claim 1, wherein said door separates a secure area from a non secure area.

4. The system of claim 1, wherein said entry authorization sensor is selected from the group consisting of a key pad, a card swipe, a badge, a fingerprint or iris reader or similar device or method and combinations there of.

5. The system of claim 1, wherein said automated video surveillance system includes at least one camera positioned to record images of persons at said door and image processing algorithms compare said recorded image to predetermined images (data) to determine the number of persons entering said door.

6. The system of claim 5, wherein said automated video surveillance system includes a plurality of cameras employed inside and/or outside said door and fusion algorithms. Said, plurality of cameras being positioned at different elevations and angles with respect to said door to optimize the view of the area of interest to produce a plurality of images.

7. The system of claim 6, wherein said plurality images are transmitted to said tailgate detection processor for processing by an algorithm adapted to compare signals from said plurality of images to distinguish between repeated images of the same person and separate images of different persons, as follows: the processing algorithms may include but not limited to people segmentation, people detection and counting, and people tracking.

8. The system of claim 1, wherein said system further includes auxiliary sensors for providing additional data to said tailgate detection processor to detect when two or more persons acting in concert are attempting to frustrate the video surveillance data being taken, said auxiliary sensors being selected from the group consisting of motion sensors, audio sensors and pressure sensors in floor proximate said door.

9. The system of claim 1, wherein when the number of valid credentialed entry signals is greater than or equal to the number of persons detected entering by the video surveillance, the system resets itself, waiting for the next valid credentialed entry signal.

10. The system of claim 1, which includes a plurality of doors as part of a facility including secure and non secure areas and said alarm is adapted to lock down all secure areas upon sounding an alarm when said credential number is less than said number of persons entering.

11. A tailgating detection system for an entry through a door or other entry port into an area of interest, comprising:
entry authorization sensor means for detecting a valid entry credential presented at said door, and transmit a signal indicative of the number of valid entry credentials detected;
tailgate detection processor means for receiving said signal indicative of the number of valid entry credentials detected;
door contact sensor means for determining the state of said door, and adapted to send a signal to said tailgate detection processor means when said door is opened and/or closed;
automated video surveillance system means for capturing images and detecting the number of persons entering said door and transmitting said images to said tailgate detection processor means for determination of the number of persons entering through said door; said tailgate detection processor means being adapted to compare the credential number of valid entry credentials detected with the number of persons detected entering; and
alarm means for triggering an alarm when said credential number is less than said number of persons entering.

12. The system of claim 11, which further includes motion sensor means for detecting motion in the area proximate said door and transmitting a signal indicative of the presence of movement in said area to said tailgate detection processor;
said tailgate detection processor means being adapted to compare the credential number of valid entry credentials detected with the number of persons detected entering upon receipt of said motion sensor signal.

13. The system of claim 11, wherein said door separates a secure area from a non secure area.

14. The system of claim 11, wherein said entry authorization sensor means is selected from the group consisting of a key pad, a card swipe, a badge, a fingerprint or iris reader or similar device or method and combinations there of.

15. The system of claim 11, wherein said automated video surveillance system means includes at least one camera positioned to record images of persons at said door and image processing algorithms compare said recorded image to predetermined images (data) to determine the number of persons entering said door.

16. The system of claim 15, wherein said automated video surveillance system means includes a plurality of cameras employed inside and/or outside said door, said plurality of cameras being positioned at different elevations and angles with respect to said door to optimize the view of the area of interest.

17. The system of claim 16, wherein said plurality images are transmitted to said tailgate detection processor means for processing by an algorithm adapted to compare signals from said plurality of images to distinguish between repeated images of the same person and separate images of different persons, as follows: the processing algorithms may include but not limited to people segmentation, people detection and counting, and people tracking.

18. The system of claim 17, wherein said system further includes auxiliary sensor means for providing additional data to said tailgate detection processor means to detect when two or more persons acting in concert are attempting to frustrate the video surveillance data being taken, said auxiliary sensors being selected from the group consisting of audio sensors and pressure sensors in floor proximate said door.

19. The system of claim 11, wherein when the number of valid credentialed entry signals is greater than or equal to the number of persons detected entering by the video surveillance system, the system resets itself, waiting for the next valid credentialed entry signal.

20. The system of claim 11, which includes a plurality of doors as part of a facility including secure and non secure areas and said alarm means is adapted to lock down all secure areas upon sounding an alarm when said credential number is less than said number of persons entering.
